(19) United States
(12) Patent Application Publication
(10) Pub. No.: US 2002/0099670 A1
(43) Pub. Date: Jul. 25, 2002

(54) Call originator access control through user-specified pricing mechanism in a communication network

(76) Inventor: Bjorn Markus Jakobsson, Hoboken, NJ (US)

Correspondence Address: Ryan, Mason & Lewis, LLP, 90 Forest Avenue, Locust Valley, NY, 11560, US

(21) Appl. No.: 09/769,511

(22) Filed: Jan. 25, 2001

(51) Int. Cl. G06F 17/60

(52) U.S. Cl. 705/400

(57) ABSTRACT

Access of telemarketers or other call originators to destination user terminals of a communication system is controlled by storing for a given one of the user terminals a set of user-specified access cost information to be applied to one or more incoming calls directed to the given user terminal. A service provider or associated network processing element of the system utilizes the user-specified access cost information to determine an amount to charge an originator of a given incoming call directed to the user terminal. The charge for the incoming call may thus include a usual toll charge, if any, as well as an additional access cost determined based from the user-specified access cost information for the destination user terminal. The access cost may be presented to the originator of the given incoming call, and the incoming call may be routed to the user terminal only if the presented access cost is approved by the originator of the given incoming call. The access cost is charged to the originator and may be credited at least in part to an account of a called party associated with the user terminal. Advantageously, the invention reduces unwanted calls, while also providing information that allows telemarketers and other call originators to better target their calls.

### FIELD OF THE INVENTION

The invention relates generally to the processing of telephone calls or other types of communications over a public switched telephone network (PSTN) or other type of communication network, and more particularly to techniques for controlling access of telemarketers or other call originators to users over such networks.

### BACKGROUND OF THE INVENTION

Telemarketing refers generally to the practice of presenting unsolicited offers of goods or services to consumers or other users via telephone or other communication network terminal. Significant advantages of telemarketing include its low cost and its ability to reach members of targeted consumer groups. These advantages have been accentuated recently by a number of trends, such as availability of increasingly accurate information on consumer behavior, development of improved predictive dialing algorithms, and reductions in long-distance telecommunication costs. As a result, telemarketing activity has been increasing to the point that it is not uncommon for many consumers to receive several telemarketing calls each and every day. Unfortunately, these calls often come at inconvenient times, and can be a source of considerable anger and frustration for consumers. The same advantages that have led to an increase in telemarketing activity have thus also created the danger of a consumer backlash that may limit its future effectiveness.

A number of known techniques address the issue of controlling access of telemarketers to consumers over a network. One such technique involves selective call blocking. In this technique, a consumer is able to specify that only those incoming calls corresponding to designated originating telephone numbers will generate a ring at the destination terminal. More particularly, the consumer can create a database of known telephone numbers, e.g., those of family members, friends, cell phones, car phones, work places, schools, etc., and a central office or other processing element of the network is configured to process incoming calls directed to the consumer such that only calls from the designated numbers will get through to the destination terminal. However, these and other existing techniques for controlling access telemarketers have been unable to provide adequate protection against the above-noted problem of excessive telemarketing activity.

A need therefore exists in the art for improved techniques for controlling access of telemarketers to consumers. It is particularly desirable that such techniques ensure that telemarketers are more likely to reach consumers that are interested in a particular type of offer, while also protecting consumers against excessive telemarketing activity.

### SUMMARY OF THE INVENTION

The invention provides improved techniques for controlling access of telemarketers or other types of call originators to user terminals of a communication system.

In accordance with one aspect of the invention, one or more elements of the system store a set of user-specified access cost information to be applied to one or more incoming calls directed to a corresponding telephone, computer, personal digital assistant or other user terminal. A service provider or associated network processing element of the system utilizes the user-specified access cost information to determine an amount to charge an originator of a given incoming call directed to the user terminal. The charge for the incoming call may thus include a usual toll charge, if any, as well as an additional access cost determined based from the user-specified access cost information for the destination user terminal. The access cost may be presented to the originator of the given incoming call, and the incoming call may be routed to the user terminal only if the presented access cost is approved by the originator of the given incoming call. The access cost is charged to the call originator and is preferably credited at least in part to an account of a called party associated with the user terminal.

The present invention may thus be configured in an illustrative embodiment so as to allow an access cost established by a called party to be presented to a caller before the call is routed through to the called party, and to allow the called party to benefit by receiving at least a portion of the access cost as paid by the caller. As noted above, the access cost for a given call is determined based on the access cost information for the destination terminal of the call as specified by the called party associated with that terminal.

In accordance with another aspect of the invention, the set of user-specified access cost information may include one or more access rules specified by the user and indicating a particular access cost for an incoming call under one or more specified conditions. As another example, the set of user-specified access control information may include one or more caller-specific access costs or caller-specific access rules associated with an identifier of a particular call originator. The set of user-specified access control information may also include one or more general access costs and general access rules to be applied to a number of incoming calls regardless of the particular call originator associated therewith. The user-specified access cost information may be entered at least in part by the user at the user terminal via a menu-driven user interface. As another example, the menu-driven user interface may be implemented at a web site of the service provider. The user-specified cost information may be stored in a centralized manner, e.g., in a database associated with the service provider, or in a distributed manner, e.g., in a database or other type of memory associated with the user terminal.

In accordance with a further aspect of the invention, the user associated with the user terminal is permitted to waive the access cost for the given incoming call, e.g., during or after the call if the call turns out to be of interest to the user. The waiver of the access cost may be in response to an offer from the call originator made after the incoming call is routed to and accepted at the user terminal.

Advantageously, the invention reduces the likelihood that a given consumer or other user will receive unwanted calls, while also providing information that can be used by telemarketers and other call originators to better target their calls.

### BRIEF DESCRIPTION OF THE DRAWINGS

FIG. 1 shows an illustrative embodiment of a communication system in which the present invention is implemented.

FIG. 2 is a block diagram of one possible implementation of a given one of the elements of the system of FIG. 1.

FIG. 3 shows example database entries that may be used to store user-specified access control information in accordance with the invention.

FIG. 4 is a flow diagram of an example access control process in accordance with the invention as implemented in the illustrative system of FIG. 1.

### DETAILED DESCRIPTION OF THE INVENTION

The present invention will be illustrated below in conjunction with an example communication system in which the access control techniques of the invention are implemented over a public switched telephone network (PSTN) or other type of communication network. It should be understood, however, that the invention is more generally applicable to any type of communication system application in which it is desirable to control access of telemarketers or other call originators to system users. For example, although well-suited for use with telephonic communications over a PSTN, the invention can also be applied to numerous other communication system applications, including applications involving e-mail solicitations over computer networks such as the Internet, pages transmitted over paging networks, and calls, e-mails, pages or other communications transmitted over wireless networks to wireless devices such as mobile telephones or personal digital assistants (PDAs).

The term “network” as used herein is intended to include a PSTN, the Internet or other computer network, a wireless network, paging network, satellite network or portions or combinations of these and other types of communication media. The term “consumer” as used herein is intended to refer to any user of a terminal or other user processing device in a network that may be a target of telemarketing activity. The term “call” is intended to include not only telephone calls, but other types of communications, including e-mails, pages and Internet telephony communications. The term “user” as used herein should be construed generally to encompass a user terminal or an actual user associated with such a terminal. Operations referred to herein as being performed by or in conjunction with a user may therefore be performed by or in conjunction with a corresponding user terminal. A “called party” is an example of one type of user, i.e., a party associated with the destination terminal of a given call.

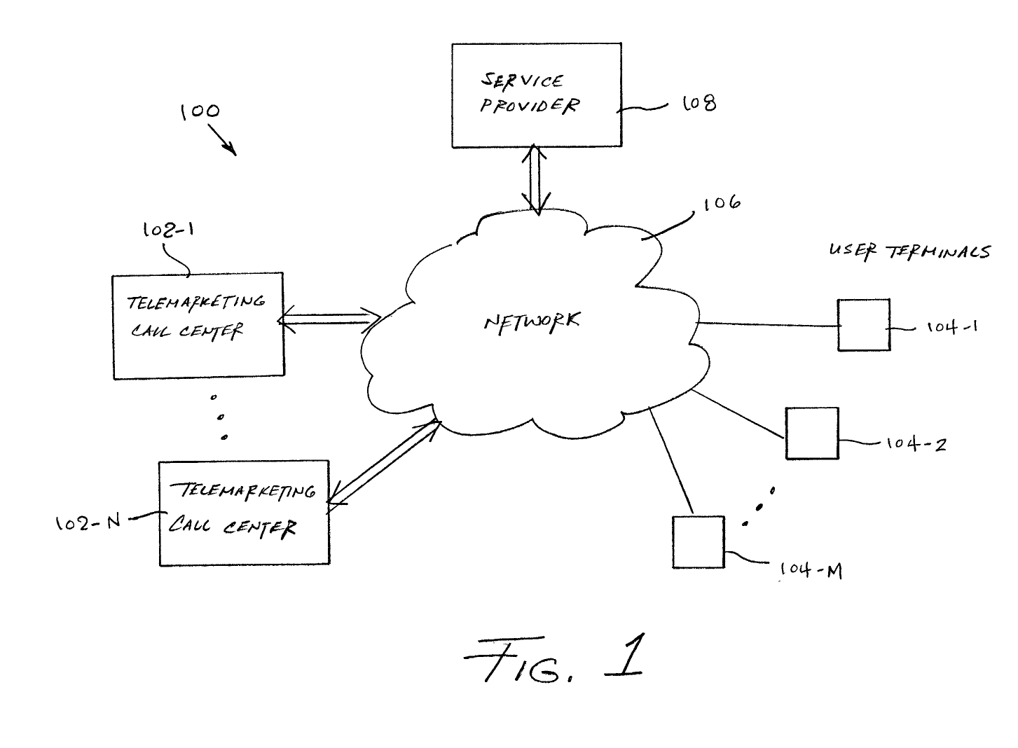

FIG. 1 shows an exemplary system 100 in which telemarketing access control techniques are implemented in accordance with the invention. The system 100 includes a number of telemarketing call centers 102-i, i=1, 2, . . . N which direct communications to a number of user terminals 104-j, j=1, 2, . . . M over a network 106. The telemarketing call centers 102 are also referred to herein as telemarketers, and may represent banks of telephones or other terminals manned by live or automated representatives. Also associated with the system 100 is a service provider 108 coupled to the network 106. In the illustrative embodiment, the service provider 108 is responsible for directing communications received from one or more of the telemarketer call centers 102 to one or more of the user terminals 104.

The network 106 may be a PSTN, a global data communications network such as the Internet, a metropolitan area network or other wide area network, or any other suitable data communication medium, as well as portions or combinations of such networks or other communication media. For example, elements 102-i and 108 may be connected by one network, while elements 108 and 104-j are connected by another network. Numerous other interconnection arrangements may also be used, as will be readily apparent to those skilled in the art.

Although shown as being separate from the network 106 in FIG. 1, the service provider 108 may represent an element of the network, such as a network processing element of the network 106, or may represent a provider of all or a portion of the network 106. For example, the service provider 108 may be a telecommunication network operator, an Internet service provider, or any other provider of a communication service over a network.

A given one of the user terminals 104-j may represent a conventional telephone, a desktop or portable personal computer, a mobile telephone, a PDA, a television set-top box or any other type of device capable of retrieving telemarketing information over network 106.

It should be understood that although only a single service provider 108 and particular numbers of telemarketers 102 and user terminals 104 are shown in the FIG. 1 embodiment, the invention is more generally applicable to any number, type and arrangement of different service providers, telemarketers and user terminals.

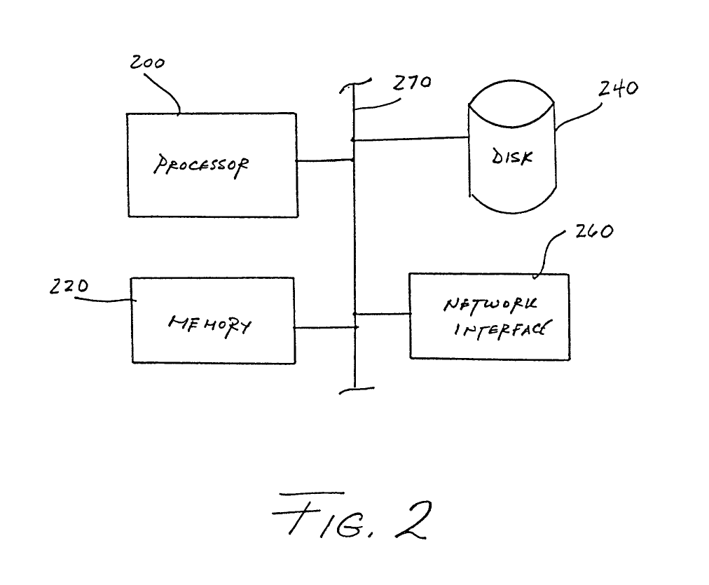

FIG. 2 shows one possible implementation of a given one of the processing elements of system 100. The implementation in FIG. 2 may represent one or more of the elements 102, 104 and 108, or portions of these elements. In this example implementation, the element of system 100 includes a processor 200, an electronic memory 220, a disk-based memory 240, and a network interface 260, all of which communicate over a bus 270. One or more of the processing elements of system 100 may thus be implemented as a personal computer, a mainframe computer, a computer workstation, an intelligent telecommunication switch, or any other type of digital data processor as well as various portions or combinations thereof. The processor 200 may represent a microprocessor, a central processing unit, a digital signal processor, an application-specific integrated circuit (ASIC), or other suitable processing circuitry. It should be emphasized that the implementation shown in FIG. 2 is simplified for clarity of illustration, and may include additional elements not shown in the figure. In addition, other arrangements of processing elements may be used to implement one or more of the elements of the system 100.

The elements 104 and 108 of system 100 execute software programs in accordance with the invention in order to provide telemarketing access control in a manner to be described in detail below. The invention may be embodied in whole or in part in one or more software programs stored in one or more of the element memories, or in one or more programs stored on other machine-readable media associated with the elements of the system 100.

In accordance with the present invention, the system 100 is configured such that users are permitted to specify access control information that controls the access of telemarketers to the corresponding user terminals. For example, in an implementation of system 100 in which network 106 represents a PSTN and service provider 108 is a central office or other network processing element associated with the PSTN, a user associated with a given terminal 104-j may specify access costs that control the manner in which one or more of the telemarketers 102 can direct calls to the given terminal. The invention includes a user interface that allows users to specify access control information in the form of access costs for particular call originators as well as general access rules that govern all incoming calls. It should be noted that call originators are also referred to herein as simply “callers.”

An access cost determined in accordance with the invention is preferably charged to the originator and credited at least in part to an account of a called party associated with the user terminal.

The present invention thus allows an access cost established by a called party to be presented to a caller before the call is routed through to the called party. As will be described in greater detail below, the access cost for a given call is determined based on the access cost information for the destination terminal of the call. This access cost information may be specified by the called party associated with the destination terminal.

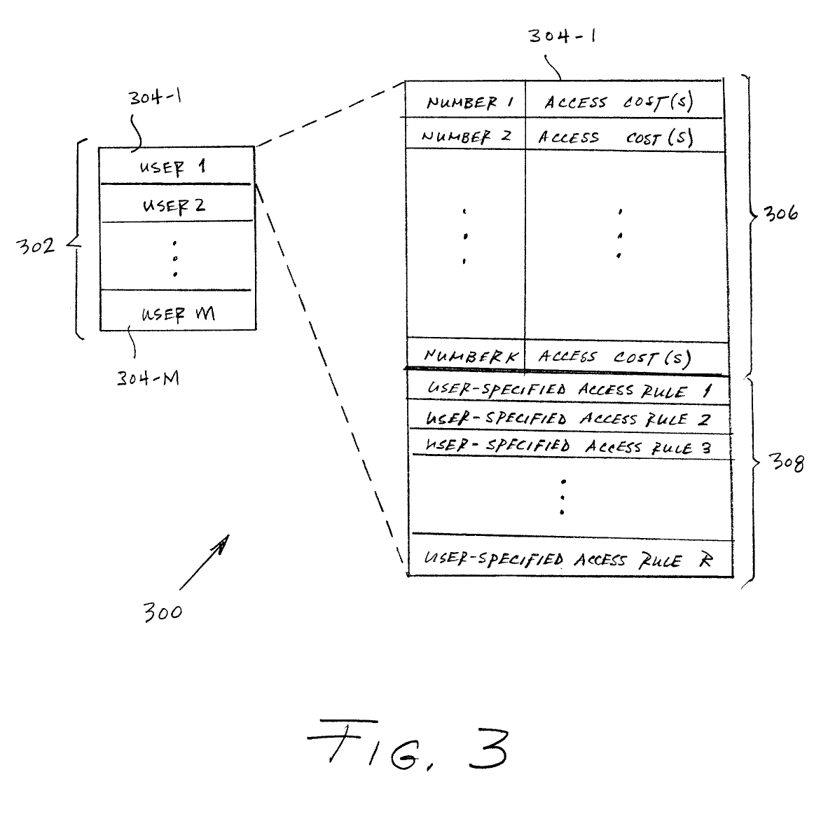

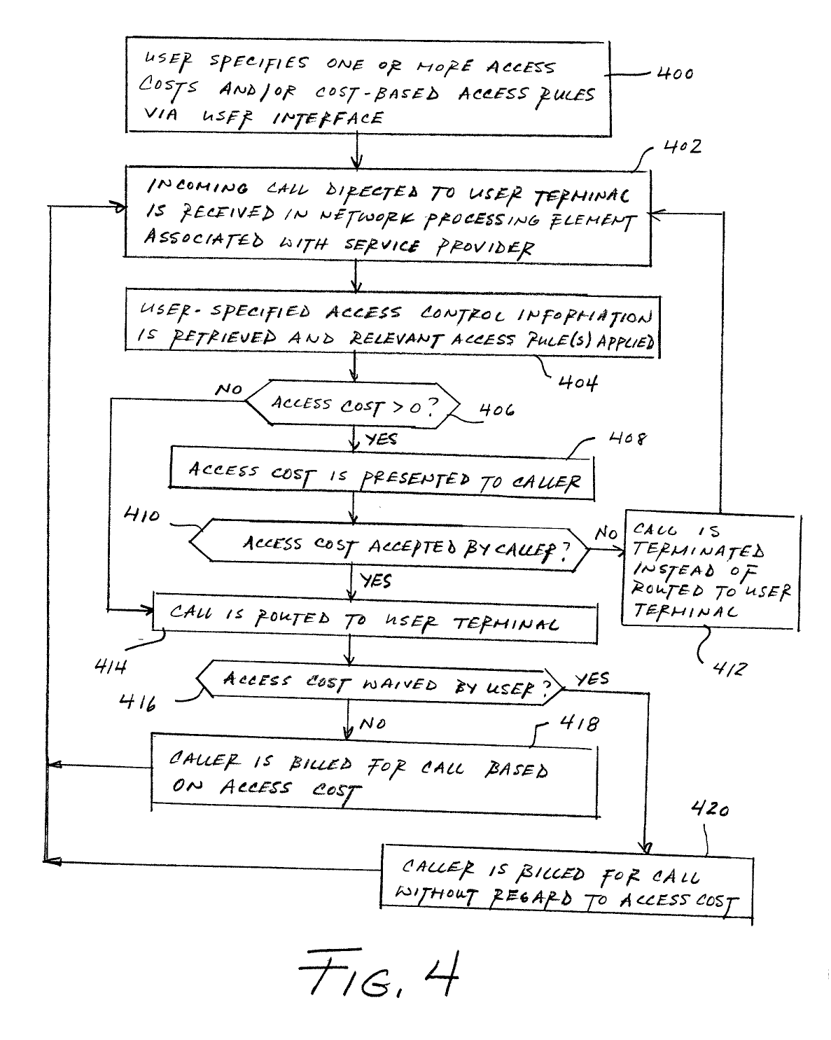

The invention will be further described in conjunction with FIGS. 3 and 4 with reference to a particular implementation of FIG. 1 involving telephone calls delivered over a PSTN to a user terminal. Other possible implementations involving other types of networks and other types of calls will be readily apparent to those skilled in the art and will not be described in detail herein.

FIG. 3 illustrates one example of the manner in which user-specified telemarketer access control information maybe stored within the system 100. In this example, a database 300 associated with the service provider 108 includes a set of entries 302 which includes an entry 304-j for each of the M user terminals 104-j. A particular one of the entries 304-1 is shown in greater detail in the figure, and includes a first portion 306 and a second portion 308.

The first portion 306 of the entry 304-1 includes a set of K call originating numbers and for each of the K originating numbers one or more corresponding user-specified access costs. The access costs for a given one of the K numbers may include a single cost to be used in all situations when an incoming call from that number directed to the user terminal is received by the service provider. Alternatively, a set of different costs may be specified for one or more of the K numbers, including, e.g., different costs for use at different times of day or under other specified circumstances. The different costs can be applied in accordance with general user-specified access rules to be described below.

The second portion 308 of the entry 304-1 includes a set of R general user-specified access rules. These rules operate without regard to the particular originating number of a given call directed to the user terminal, and may include specification of one or more access costs to be used in certain specified situations. Examples of user-specified access rules include the following:

1. If the caller identifier (ID) of a given incoming call is not revealed, the access cost is $2.00.

2. If the incoming call is made at a time later than 10 PM, the access cost is $0.25.

3. If the incoming call originates from one of a specified list of area codes, the access cost is $0.15.

4. If the incoming call is identified as being from a call originator that has previously placed a call to the user terminal, the access cost is $0.10.

5. If the incoming call is identified as being from one of a specified list of numbers recently called by a user, the access cost is $0.

6. If the incoming call is identified as being from one of a specified list of “address book” numbers identified by the user, the access cost is $0.

In accordance with the invention, the user-specified access costs applicable to a given incoming call are generally added to the cost of the call as billed to the call originator. Advantageously, this approach not only limits telemarketing activity by forcing telemarketers to better target their calls, it also allows users to provide useful feedback to telemarketers regarding which calls the users would be inclined to accept in the future.

As will be described below, the user-specified access costs may be viewed as “worst case” costs that can be waived, partially or entirely, by the user during or after the call. This waiver can be implemented through push-button or voice commands entered by the user at the user terminal and detected by the service provider.

The access costs can also be modified by the user during or after a given call, using the above-noted user interface. For example, the user may remain on the line after completion of a call, call another designated telephone number or visit a password-protected web site provided by the service provider, and then enter commands to direct that the most recent call originator be moved from one charging category to another. As another example, this modification of access costs may be implemented via an automated menu-driven process, provided to the user via the user terminal, at or near the completion of the call.

FIG. 4 is a flow diagram of an example access control process that may be implemented in the system of FIG. 1 using stored user-specified access control information such as that described in conjunction with FIG. 3. In step 400, a given user specifies one or more access costs and/or cost-based access rules via a user interface. The user interface may be provided at a corresponding user terminal 104-j, or at another terminal capable of interacting with the service provider 108. In step 402, an incoming call directed to the user terminal 104-j is received in a network processing element associated with the service provider 108. User-specified access control information for the given user is then retrieved and the relevant rule or rules are applied, as indicated in step 404. As noted in conjunction with FIG. 3, the user-specified access control information may include either caller-specific costs or general access rules or both. For the caller-specific costs, the particular call originator or originating number may be determined using conventional techniques such as caller ID, automatic number identification (ANI), or other similar techniques. The operation of such techniques is well understood in the art and therefore not further described herein.

Application of the relevant general access rules in conjunction with any caller-specific access cost yields an access cost for the incoming call. This access cost is typically a cost that is paid by the call originator in addition to the usual toll charges for the call. In step 406, a determination is made as to whether the determined access cost is greater than zero. If the access cost is greater than zero, the cost is presented to the call originator for approval in step 408. This step may be implemented in a manner similar to that used in conjunction with conventional collect calling, i.e., via a human or automated operator getting on the line and asking if the caller will accept responsibility for paying the user-specified access cost. Other techniques may also be used, e.g., the access cost may be displayed on a terminal of a telemarketer that originated the incoming call. As another example, a given telemarketer or other call originator may establish a policy with the service provider that all access costs below a specified threshold are to be automatically deemed accepted by that call originator. In the latter example, the service provider need not present access costs that are below the specified threshold to the call originator.

If the access cost is not accepted by the call originator in step 410, the call is terminated in step 412 instead of being routed to the destination user terminal, and the process returns to step 402 to await the next incoming call directed to the given user terminal. If the access cost is accepted by the call originator in step 410, or if the access cost is determined to be zero in step 406, the incoming call is routed to the destination user terminal in step 414.

As noted previously, the access cost can be waived by the user during or after the call, e.g., via entry of designated commands. This is indicated in step 416, which determines if the user has waived the access cost. The user may waive the access cost if the call is actually of interest to the user, or in response to special offers made by the telemarketer during the call. For example, a telemarketer may offer the user a certain discount on a product or service in exchange for the user waiving the access cost. If the user does not waive the access cost in step 416, the call originator is billed for the usual toll charges, if any, as well as the access cost, as indicated in step 418, and the process returns to step 402 to await the next incoming call directed to the given user terminal. If the user does waive the access cost in step 420, the call originator is billed for the call without regard to the access cost, i.e., is billed only the usual toll charges for the call, if any, and the process then returns to step 402 to await the next incoming call.

In accordance with the invention, the access cost for a given call as determined in the manner illustrated in FIG. 4 may be credited in whole or in part to an account of the user that is the target of the call. For example, the user may have an account with the service provider in which at least a portion of the access cost appears as a credit to offset other charges, e.g., outgoing calls made by that user under the same account. Of course, some or all of the access cost may be retained by the service provider to offset the costs associated with providing the service.

The telemarketing access control process described above can thus be offered as a service by the service provider 108 to users of the system 100. The service may be offered to the users free of charge, with the service provider paying for the service through the billing of user-specified access costs to callers. As noted above, the service provider 108 may also provide part of the access cost profits back to the users, e.g., as credits on their own telephone bills. As other examples, the service can be provided for a fixed monthly fee, or a flat fee per call. The access control service can employ particular area codes or exchange codes to identify the user terminals that service, or can allow any telephone number to be associated with the service. Advantageously, this type of service may be implemented in an existing PSTN, without requiring any modification to existing telephones. It may also be implemented in newly-developed user terminals, e.g., in web-enabled wireless telephones or PDAs, through appropriate software modules, attachments, etc.

It should be noted that the invention does not require per-call billing. For example, the service provider may bill access costs and other charges in accordance with a service plan based on, e.g., flat monthly or weekly charges.

One or more databases having entries of the type shown in FIG. 3 may be used to implement the access control process. These one or more databases may be centralized at the service provider 108, or alternatively may be distributed over multiple network elements or user terminals. For example, the portions of the database(s) for particular user terminals can be located in the central office or other network processing element associated with those user terminals. As another example, the database entry for a particular user may be stored on the corresponding user terminal, and the database entry accessed by the service provider prior to or during call setup. In addition, the service provider 108 need not be “on-line” at all times with the network 106, i.e., need not be continuously connected to the network 106. For example, the service provider may be presented by the call originator with digital signatures that have been given to the call originator by certain users, the digital signatures indicating that the call originator has agreed to pay user-specified access costs to obtain telemarketing access to the users. This type of implementation allows the service provider to operate in an at least partially off-line mode relative to the network 106.

As noted previously, a significant advantage of the present invention is that it discourages unwanted telemarketing calls. However, the invention also allows the service provider to inform the telemarketers regarding the types of calls that particular users want to receive, as indicated by low or waived access costs for certain incoming calls. This gives telemarketers an advantage in determining what users are interested in their goods or services. For example, users can specify low or waived access costs for calls from known home mortgage telemarketers, which indicates that the user generally wants to be contacted regarding home mortgages. This “call invitation” aspect of the invention can be used by telemarketers to create improved user profiles and to increase the precision with which they target calls. The user can also use the access costs to specify what times of the day he or she is the most willing to be called, which is another piece of user preference information that is of value to telemarketers. The service provider can increase its profits by selling such information to the telemarketers, preferably with the consent of the users.

It should be understood that the above-described embodiments of the invention are illustrative only. For example, the invention can be applied to a wide variety of different types of communication systems, networks, service providers, telemarketers and user terminals. In addition, although illustrated in the context of telemarketing applications, the invention is also applicable to controlling access of other types of call originators. Furthermore, the particular access control process utilized in a given embodiment may vary depending upon factors such as the pricing mechanisms used, the type of network and service provider, and the type of user interface through which access costs are specified by the system users. These and numerous other alternative embodiments within the scope of the following claims will be apparent to those skilled in the art.

What is claimed is:

1. A method for controlling access of call originators to user terminals in a communication system, the method comprising the steps of:
storing for a given user terminal of the system a set of user-specified access cost information to be applied to one or more incoming calls directed to the user terminal; and
determining an amount to charge an originator of a given incoming call directed to the user terminal based at least in part on an access cost for the given incoming call as determined from the user-specified access cost information.

2. The method of claim 1 wherein the access cost is presented to the originator of the given incoming call and the incoming call is routed to the user terminal only if the presented access cost is approved by the originator of the given incoming call.

3. The method of claim 1 wherein the access cost is charged to the originator and credited at least in part to an account of a called party associated with the user terminal.

4. The method of claim 1 wherein the user terminal comprises a telephone.

5. The method of claim 1 wherein the user terminal comprises a computer.

6. The method of claim 1 wherein the user terminal comprises a personal digital assistant.

7. The method of claim 1 wherein the set of user-specified access cost information comprises one or more access rules specified by the user and indicating a particular access cost for an incoming call under one or more specified conditions.

8. The method of claim 1 wherein the set of user-specified cost information is stored in a database associated with a service provider that implements the determining step.

9. The method of claim 1 wherein the set of user-specified cost information is stored in a database associated with the user terminal.

10. The method of claim 1 wherein the originator of the given incoming call comprises a telemarketer.

11. The method of claim 1 wherein a user associated with the terminal is permitted to waive the access cost for the given incoming call.

12. The method of claim 11 wherein the waiver of the access cost is in response to an offer from the call originator made after the incoming call is routed to and accepted at the user terminal.

13. The method of claim 1 wherein the set of user-specified access control information comprises at least one of a caller-specific access cost and a caller-specific access rule associated with an identifier of a particular call originator.

14. The method of claim 1 wherein the set of user-specified access control information comprises at least one of a general access cost and a general access rule to be applied to a plurality of incoming calls regardless of the particular call originator associated therewith.

15. The method of claim 1 wherein the user-specified access cost information is at least in part entered by the user at the user terminal via a menu-driven user interface.

16. The method of claim 1 wherein the user-specified access cost information is a least in part entered by the user at a web site associated with a service provider that implements the storing and determining steps.

17. A processor-based system for controlling access of call originators to user terminals in a communication system, the system comprising:
one or more processing elements configured to store for a given user terminal of the system a set of user-specified access cost information to be applied to one or more incoming calls directed to the user terminal, and to determine an amount to charge an originator of a given incoming call directed to the user terminal based at least in part on an access cost for the given incoming call as determined from the user-specified access cost information.

18. A machine-readable medium containing one or more software programs for controlling access of call originators to user terminals in a communication system, wherein the one or more programs when executed implement the steps of:
storing for a given user terminal of the system a set of user-specified access cost information to be applied to one or more incoming calls directed to the user terminal; and
determining an amount to charge an originator of a given incoming call directed to the user terminal based at least in part on an access cost for the given incoming call as determined from the user-specified access cost information.

19. An apparatus for use in controlling access of call originators to user terminals in a communication system, the apparatus comprising:
a memory for storing for a given user terminal of the system a set of user-specified access cost information to be applied to one or more incoming calls directed to the user terminal; and
a processor coupled to the memory and operative to determine an amount to charge an originator of a given incoming call directed to the user terminal based at least in part on an access cost for the given incoming call as determined from the user-specified access cost information.
